(19) United States
(12) Patent Application Publication
(10) Pub. No.: US 2015/0304566 A1
(43) Pub. Date: Oct. 22, 2015

(54) DISPLAY APPARATUS AND IMAGE COMPOSITION METHOD THEREOF

(71) Applicant: SAMSUNG ELECTRONICS CO., LTD., Suwon-si (KR)

(72) Inventors: Ju-hee SEO, Hwaseong-si (KR); Han-tak KWAK, Suwon-si (KR); Se-Hoon KIM, Suwon-si (KR)

(73) Assignee: SAMSUNG ELECTRONICS CO., LTD., Suwon-si (KR)

(21) Appl. No.: 14/688,606

(22) Filed: Apr. 16, 2015

(30) Foreign Application Priority Data
Apr. 16, 2014 (KR) 10-2014-0045197

(51) Int. Cl. H04N 5/232; G06T 7/00; H04N 5/225

(52) U.S. Cl. CPC H04N 5/23293; H04N 5/2258; G06T 7/0081; H04N 5/23216

(57) ABSTRACT

A display apparatus is disclosed. The display apparatus includes a user interface configured to receive a user command to select a mode for setting a location in which an image which is photographed in a back side of the display apparatus is composed with an object which is photographed in a front side of the display apparatus, a camera configured to photograph the front side and the back side of the display apparatus, and a controller configured to segment an object image from an image of the object which is photographed in the front side, compose the segmented object image with the image which is photographed in the back side according to the selected mode, and store the composed image.

### CROSS-REFERENCE TO RELATED APPLICATIONS

This application claims priority from Korean Patent Application No. 10-2014-0045197, filed on Apr. 16, 2014, in the Korean Intellectual Property Office, the disclosure of which is incorporated herein by reference in its entirety.

### BACKGROUND

1. Field

Apparatuses and methods consistent with exemplary embodiments relate to a display apparatus and an image composition method thereof, and more particularly, to a display apparatus which composes an image that is photographed by a display apparatus and an image composition method thereof.

2. Description of the Related Art

With development of electronic technologies, various mobile devices including a smartphone are equipped with photographing means and provide a photographing function. Accordingly, a user is able to photograph him/herself, a desired person, a desired place, or the like using a mobile device.

In this case, there is a drawback that a user who photographs is excluded from a photo which is taken by the user. Thus, there is a need for including a user who photographs in a photo which is taken by the user.

### SUMMARY

Exemplary embodiments may overcome the above disadvantages and other disadvantages not described above. However, it is understood that the exemplary embodiments are not required to overcome the disadvantages described above, and may not overcome any of the problems described above.

The exemplary embodiments are related to a display apparatus which performs photographing in a front side and a back side, respectively, and composes an object photographed in the front side at a specific area of an image which is photographed in the back side, and a method of image composition thereof.

According to an aspect of an exemplary embodiment, there is provided a display apparatus which may include a user interface configured to receive a user command to select a mode for setting a location in which an image which is photographed in a back side of the display apparatus is composed with an object which is photographed in a front side of the display apparatus; a camera configured to photograph the front side and the back side of the display apparatus; and a controller configured to segment an object image from an image of the object which is photographed in the front side, compose the segmented object with the image which is photographed in the back side according to the selected mode, and store the composed image.

If the image photographed in the back side includes a plurality of objects, the mode may be a mode for setting a location in which the object which is photographed in the front side of the display apparatus is composed based on a location of the plurality of objects.

The controller may adjust a size of the segmented object image to correspond to a size of an object included in the image photographed in the back side.

The controller, in response to selecting a first mode, may compose the segmented object at a left area or a right area of the image which is photographed in the back side.

The controller, in response to selecting a second mode, may compose the segmented object among a plurality of objects included in the image which is photographed in the back side.

The controller may display a preview screen in which the object photographed in the front side is overlapped with the image photographed in the back side.

The controller may display on the preview screen a guide graphic user interface (GUI) indicating the location in which the object that is photographed in the front side is composed with the image that is photographed in the back side, and compose the segmented object at the location in which the guide GUI is displayed on the preview screen.

The guide GUI may be an icon or an image of the object which is photographed in the front side.

The controller may display, in response to selecting a first mode, the guide GUI at a left area of the image photographed in the back side, and display an icon at a right area of the image as a candidate area.

The controller may display, in response to selecting a second mode, the guide GUI at an area in which the object photographed in the front side is composed among a plurality of objects included in the image photographed in the back side, and display an icon at a location among the plurality of objects as a candidate area.

According to an aspect of an exemplary embodiment, there is provided an image composition method of a display apparatus which may include receiving a user command to select a mode for setting a location in which an image which is photographed in a back side of the display apparatus is composed with an object which is photographed in a front side of the display; photographing the front side and the back side of the display apparatus; and segmenting an object image from an image of the object which is photographed in the front side, composing the segmented object with the image which is photographed in the back side according to the selected mode, and storing the composed image.

If the image photographed in the back side includes a plurality of objects, the mode may be a mode for setting a location in which the object which is photographed in the front side of the display apparatus is composed based on a location of the plurality of objects.

The composing may include adjusting a size of the segmented object image to correspond to a size of an object included in the image photographed in the back side.

The composing may include, in response to selecting a first mode, composing the segmented object at a left area or a right area of the image which is photographed in the back side.

The composing may include, in response to selecting a second mode, composing the segmented object among a plurality of objects included in the image which is photographed in the back side.

The method may further include displaying a preview screen in which the object photographed in the front side is overlapped with the image photographed in the back side.

The displaying may include displaying on the preview screen a guide GUI (graphic user interface) indicating the location in which the object that is photographed in the front side is composed with the image that is photographed in the back side, and composing the object at a location in which the guide GUI is displayed on the preview screen.

The guide GUI may be an icon or an image of the object which is photographed in the front side.

The displaying may include, in response to selecting a first mode, displaying the guide GUI at a left area of the image photographed in the back side and displaying an icon at a right area of the image as a candidate area.

The displaying may include, in response to selecting a second mode, displaying the guide GUI at an area in which the object photographed in the front side is composed among a plurality of objects included in the image photographed in the back side, and displaying an icon at a location among the plurality of objects as a candidate area.

According to the aforementioned various exemplary embodiments, an object image of an object photographed in the front side may be composed in an image photographed in the back side naturally.

### BRIEF DESCRIPTION OF THE DRAWINGS

The above and/or other aspects will be more apparent by describing in detail exemplary embodiments with reference to the accompanying drawings, in which:

FIG. 1 is a block diagram illustrating a configuration of a display apparatus according to an exemplary embodiment;

FIGS. 2A-9 and 11 are views to describe a method of composing an object which is photographed in a front side with an image which is photographed in a back side according to an exemplary embodiment;

FIG. 10 is a block diagram to describe a detailed configuration of a display apparatus according to an exemplary embodiment; and

FIG. 12 is a flowchart to describe an image composition method of a display apparatus according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, the same reference numerals are used for the same elements, even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

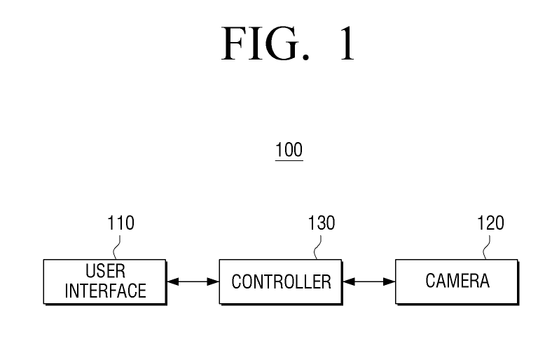

FIG. 1 is a block diagram illustrating a configuration of a display apparatus 100 according to an exemplary embodiment.

The display apparatus 100 according to the exemplary embodiment includes a user interface 110, a camera 120, and a controller 130. Here, the display apparatus 100 may be implemented as various types of devices such as a smart phone, a tablet, or a personal digital assistant (PDA), but is not limited thereto. A device which has photographing function may be the display apparatus 100.

The user interface 110 may be realized as a touch screen and receive various user commands. The user interface 110 may receive a user command to select a mode (hereinafter, a mode selection command).

Here, a mode indicates a mode for setting a location where an object which is photographed in a front side of the display apparatus 100 is composed with an image which is photographed in a back side of the display apparatus 100.

For example, a mode may include a first mode which composes an object that is photographed in a front side with an image that is photographed in a back side so that the object is located at a left area or a right area of the image which is photographed in a back side, and a second mode which composes an object that is photographed in a front side with an image that is photographed in a back side so that the object is located among a plurality of objects that are included in the image that is photographed in a back side.

If the image that is photographed in a back side includes a plurality of objects, the mode may be for setting a location in which an object that is photographed in a front side is composed based on a location of the plurality of objects.

The user interface 110 may receive various commands including a photographing start command, a graphical user interface (GUI) manipulation command, and a photographing command, or the like, and details of these user commands will be described below.

The camera 120 photographs a front side and a back side of the display apparatus 100. The camera 120 may include a first camera (not shown) to photograph a front side of the display apparatus 100 and a second camera (not shown) to photograph a background of the display apparatus 100.

The controller 130 controls overall operations of the display apparatus 100. The controller 130 may include microprocessor (or central processing unit (CPU)), random access memory (RAM) for operation of the display apparatus 100, and read only memory (ROM). In this case, these modules may be implemented as type of system on chip (SoC).

For example, when a photographing start command is input through the user interface 110, the controller 130 may control the camera 120 to photograph a front side and a back side of the display apparatus 100 at the same time.

Here, the photographing start command may be a user command to execute a camera application which is installed in the display apparatus 100.

For example, when an icon which indicates a camera application displayed on a home screen of the display apparatus 100 is selected, the controller 130 executes the camera application and controls the camera 120 to photograph the front side and the back side of the display apparatus 100.

Meanwhile, this is merely exemplary, the controller 130, when an additional user command is input after the camera application is executed, may control the camera 120 to photograph a front side and a back side of the display apparatus 100. Here, the additional user command may be a separate menu item provided by the camera application, such as a user command to select a menu item to photograph a front side and a back side at the same time.

In this case, the controller 130 may display on a pre-view screen an image which is photographed in a front side of the display apparatus 100 and an image which is photographed in a back side of the display apparatus 100 through the user interface 110.

Here, the pre-view screen indicates a screen in which an image which is photographed in a front side may be overlapped with an image which is photographed in a back side.

The controller 130 may display a user interface (UI) screen (hereinafter, a mode selection screen) to select a mode through the user interface 110.

In this case, the mode selection screen may include a menu item to set a mode. Accordingly, a user may select a menu item which is displayed in the screen and set the display apparatus 100 as a first mode or a second mode.

Thereafter, the controller 130 may determine a location in which an object which is photographed in a front side of the display apparatus 100 is composed with an image which is photographed in a back side of the display apparatus 100 according to a selected mode.

In this case, the controller 130, when a plurality of objects are included in the image which is photographed in a back side, may determine a location in which an object which is photographed in a front side is composed according to the selected mode based on a location of the plurality of objects.

Hereinafter, it is assumed that an object which is included in each of the image which is photographed in a front side and a back side is a person. In this case, the person who is photographed in a front side may be a user who performs photographing through display apparatus 100 and a person who is photographed in a back side may be a subject to be photographed by the user.

If a selected mode is the first mode, the controller 130, based on a location of a plurality of objects included in an image which is photographed in a back side of the display apparatus 100, may determine a left area or a right area of the image which is photographed in a back side as a location in which an object which is photographed in a front side may be composed.

For example, the controller 130 may determine a left area and a right area of a plurality of objects included in an image which is photographed in a back side as candidate areas in which an object which is photographed in a front side may be composed, and determine one of the candidate areas as an area in which an object which is photographed in a front side may be composed.

The controller 130 may detect a plurality of objects from an image which is photographed in a back side. For example, the controller 130 may recognize contour (e.g., contour of face and body) of a person based on a difference of tone values among adjacent pixels from an image which is photographed in a back side, and detect a person from the image. However, this is merely exemplary, and various methods which are well known may be used.

Accordingly, the controller 130 may determine a left area or a right area of a plurality of objects as a candidate area where an object which is photographed in a front side may be composed.

In addition, the controller 130 may determine locations of a plurality of objects from an image which is photographed in a back side, and may determine, based on the locations of the plurality of objects, one of a left area and a right area as an area in which an object which is photographed in a front side may be composed.

In this case, the controller 130 may calculate a size of the left area and the right area of the plurality of objects and determine locations of the plurality of objects from an image which is photographed in a back side. For example, the controller 130 may determine that a plurality of objects are lean to one side at an area having a smaller size by calculating. That is, if a size of the left area is larger than a size of the right area, the controller 130 may determine that a plurality of objects are located to lean to the right area, and if a size of the right area is larger than a size of the left area, the controller 130 may determine that a plurality of objects are located to lean to the left area.

The controller 130 determines an area in which an object which is photographed in a front side is composed, based on a location of the plurality of objects.

The controller 130, in response to determining that the plurality of objects are located to lean to the right area, may determine the left area as an area in which the object which is photographed in a front side is to be composed, and the controller 130, in response to determining that the plurality of objects are located to lean to the left area, may determine the right area as an area in which the object which is photographed in a front side is to be composed.

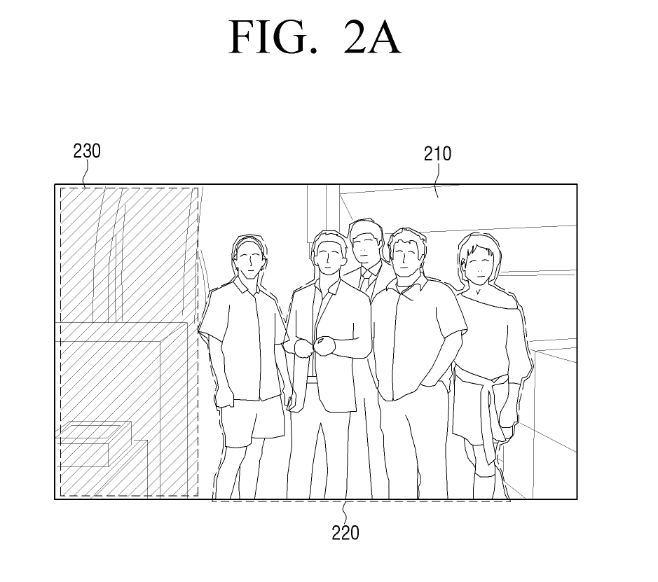

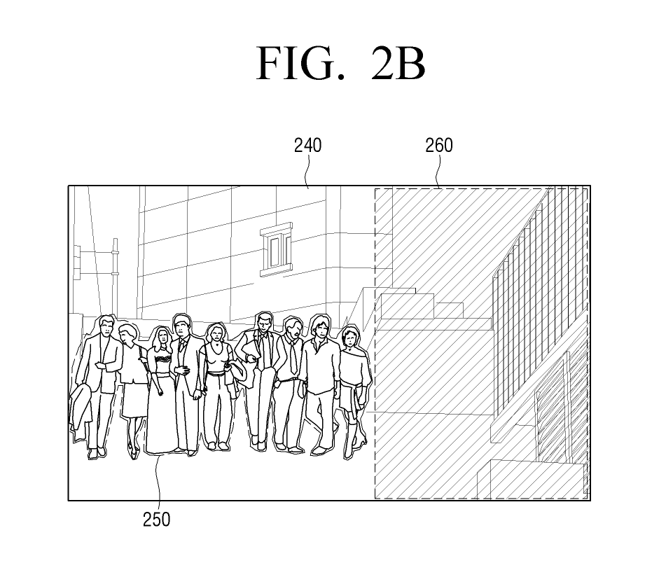

FIGS. 2A and 2B illustrate an image which is photographed in a back side.

Referring to FIG. 2A, a plurality of people 220 are located to lean to a right side of the image 210 which is photographed in a back side, and the controller 130 may determine a left area 230 of the plurality of people 220 as an area in which an object image of the object photographed in a front side is to be composed.

Referring to FIG. 2B, a plurality of people 250 are located to lean to a left side in the image 240 which is photographed in a back side, and the controller 130 may determine a right area 260 of the plurality of people 250 as an area in which an object image of the object photographed in a front side is to be composed.

When a selected mode is a second mode, the controller 130 may determine, based on a location of a plurality of objects included in an image which is photographed in a back side of the display apparatus 100, one of areas among a plurality of objects as a location in which an object which is photographed in a front side is to be composed.

The controller 130 may determine a candidate area in which an object which is photographed in a front side is to be composed with an image which is photographed in a back side.

The controller 130 may determine an area which satisfies at least one condition from among conditions as explained below, from an image which is photographed in a back side, as a candidate area.

Condition 1) From among areas between a plurality of people included in an image photographed in a back side, an area of which space between people satisfies a preset condition.

For example, the controller 130 may determine areas between faces of a plurality of people who are photographed in a back side, and determine an area which satisfies a specific condition as a candidate area in which a person who is photographed in a front side is to be composed. Here, the area which satisfies the specific condition may be an area which has the shortest space from among areas in which space between faces is larger than length of face of adjacent people.

Condition 2) When legs of a plurality of people are included in an image which is photographed in a back side, an area in which spaces between legs satisfy a preset condition.

For example, the controller 130 may determine, when legs of a plurality of people are included in an image which is photographed in a back side, a left area and a right area of a person whose legs are not spaced apart from each other as a candidate area in which a person who is photographed in a front side is to be composed. Here, the left area and the right area may be areas where a person is not present from an image which is photographed in a back side.

Condition 3) A surrounding area of a person who has a preset relationship with a person who is photographed in a front side from among a plurality of people included in an image which is photographed in a back side.

For example, the controller 130 may determine a left area and a right are of a person who has a close relationship with a person who is photographed in a front side, from among a plurality of people included in an image which is photographed in a back side, as a candidate area in which a person who is photographed in a front side is to be composed. Here, the left area and the right area may be areas where a person is not present from an image which is photographed in a back side.

Meanwhile, a close relationship may be determined based on calling history, photos taken in the past, social network activities, or the like.

For example, the controller 130 may determine, when a profile photo of another user is registered in a contact list, by comparing the profile photo of the another user with faces of a plurality of people included in an image which is photographed in a back side, a person who has the largest number of calls from among the plurality of people as a person having a close relationship.

In addition, the controller 130 may determine, by comparing the faces of a plurality of people included in an image which is photographed in a back side with an image which is photographed in the past, a person who is present in a photo photographed in the past from among the plurality of people included in the image, as a person having a close relationship.

In addition, the controller 130 may determine a person who has a relationship in a social network with a person who is photographed in a front side from among a plurality of people included in an image which is photographed in a back side as a person having a close relationship.

In this case, the controller 130 may determine, based on user information prestored in the display apparatus 100, people who have a relationship with a user of the display apparatus 100 in a social network, and determine a person who has a relationship in a social network from among a plurality of people included in an image which is photographed in a back side as a person having a close relationship, with reference to a profile photo of people with whom a user has a relationship.

Condition 4) A peripheral area of a person who has the same gender with a person who is photographed in a front side from among a plurality of people included in an image which is photographed in a back side.

For example, the controller 130 may determine a left area and a right area of a person who has the same gender with a person who is photographed in a front side from among a plurality of people included in an image which is photographed in a back side, as a candidate area where a person who is photographed in a front side may be composed. Here, the left area and the right area may be areas where a person is not present from an image which is photographed in a back side.

In this case, the controller 130 may determine gender of people included in each image, based on shape of eyes, nose, lips of people photographed, contour of face, shape of hair, length of hair, or the like.

Then, the controller 130 may determine one of the candidate areas as an area in which an object which is photographed in a front side is to be composed.

The controller 130 may assign weights to each of the aforementioned conditions, and determine a candidate area which has the highest weight from among the candidate areas which satisfy the aforementioned conditions as an area in which an object which is photographed in a front side may be composed.

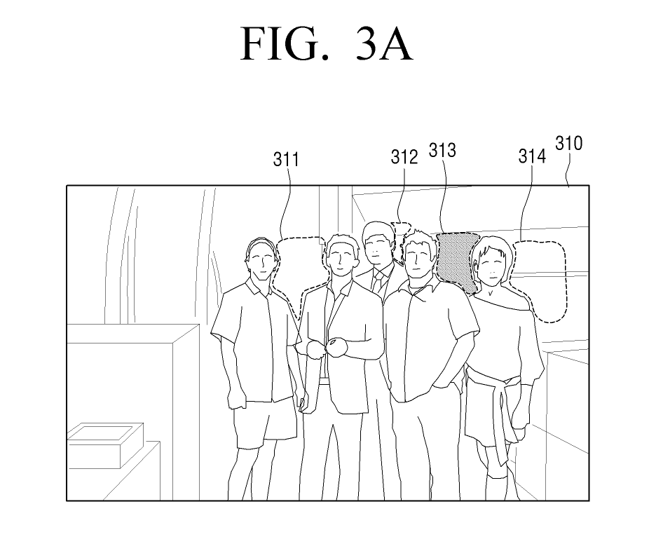

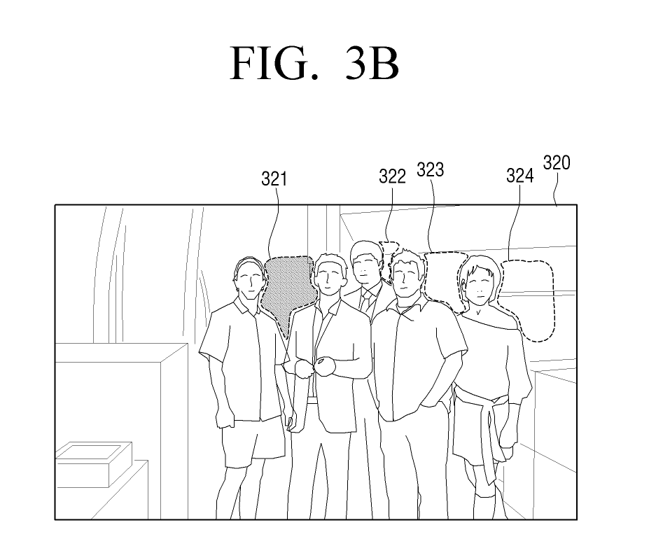

For example, FIG. 3A illustrates an image 310 which is photographed in a back side in which weight 4 is assigned to condition 1, weight 1 to condition 2, weight 2 to condition 3, and weight 3 to condition 4.

In this case, from the image 310 which is photographed in a back side, an area 311 satisfies condition 1, areas 313 and 314 satisfy condition 2, areas 312 and 313 satisfy condition 3, and areas 313 and 314 satisfy condition 4, and thus, the areas 311 to 314 may be candidate areas in which an object which is photographed in a front side may be composed.

Accordingly, the controller 130 may assign weight 4 to the area 311, weight 2 to the area 312, weight 6 (=1+2+3) to the area 313, and weight 4 (=1+3) to the area 314, and may determine the candidate area 313 which has the highest weight as a location in which a person who is photographed in a front side may be composed.

Meanwhile, the controller 130 may assign priority to each of the aforementioned conditions, and determine an area which has the highest priority from among the candidate areas satisfying the aforementioned conditions as an area in which an object which is photographed in a front side may be composed.

For example, FIG. 3B illustrates an image 320 which is photographed in a back side in which priority 1 is assigned to condition 1, priority 2 to condition 2, priority 4 to condition 3, and priority 3 to condition 4.

In this case, from the image 310 which is photographed in a back side, when the area 321 satisfies condition 1, areas 323 and 324 satisfy condition 2, areas 322 and 323 satisfy condition 3, and areas 323 and 324 satisfy condition 4, the areas 321 to 324 may be candidate areas in which an object which is photographed in a front side may be composed.

Accordingly, the controller 130 may assign priority 1 to the area 321, priority 4 to the area 322, priority 2 to the areas 323 and 324, and determine the area 321 which has the highest priority as an area in which a person who is photographed in a front side may be composed.

As described above, the controller 130 may determine a location in which an object which is photographed in a front side may be composed according to modes.

Meanwhile, the controller 130, in response to determining a location in which an object which is photographed in a front side may be composed, may display on a preview screen a guide graphic user interface (GUI) indicating a location in which an object which is photographed in a front side may be composed with an image which is photographed in a back side.

In this case, the guide GUI may be a preset icon or an image of an object which is photographed in a front side. A type of the guide GUI may be set or changed according to a user command.

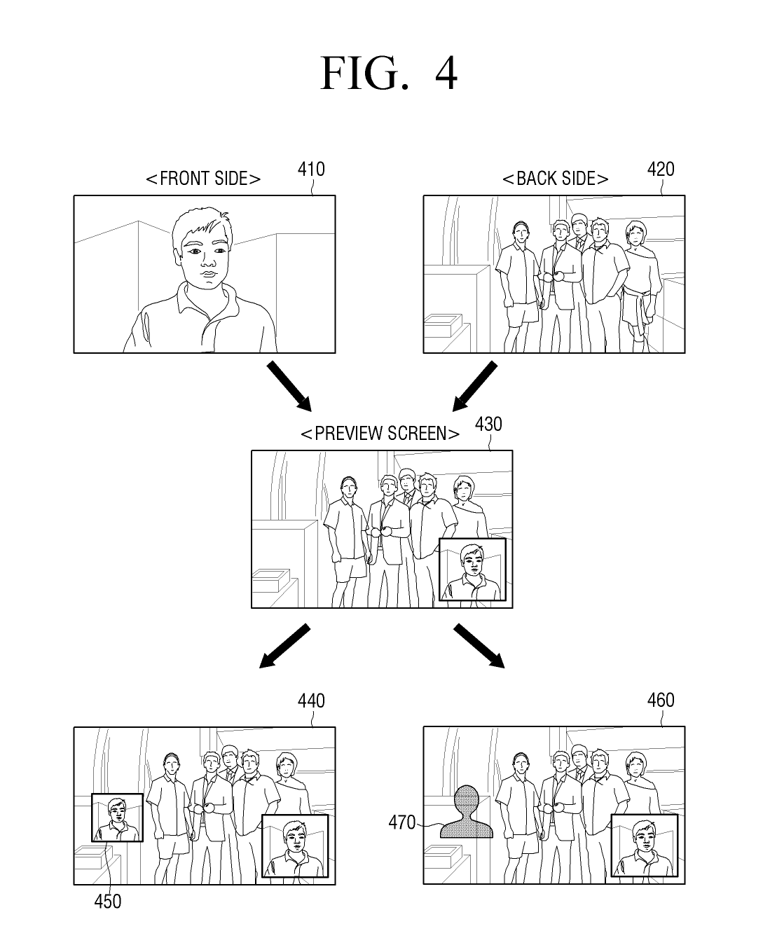

Referring to FIG. 4, when an image 410 which is photographed in a front side and an image 420 which is photographed in a back side are illustrated in a left upper part and a right upper part of FIG. 4, respectively, a preview screen 430 is illustrated in the center of FIG. 4.

For example, as illustrated in FIG. 2A, if a selected mode is the first mode, and a left area of an image 420 which is photographed in a back side is determined as a location in which a person who is photographed in a front side may be composed.

In this case, as illustrated in left lower part of FIG. 4, the controller 130 may overlay and display on a left area of a preview screen 440 a guide GUI 450 which is an image photographed in a front side.

Alternatively, as illustrated in right lower part of FIG. 4, the controller 130 may overlay and display on a left area of a preview screen 460 a guide GUI 470 which is an icon of a specific shape.

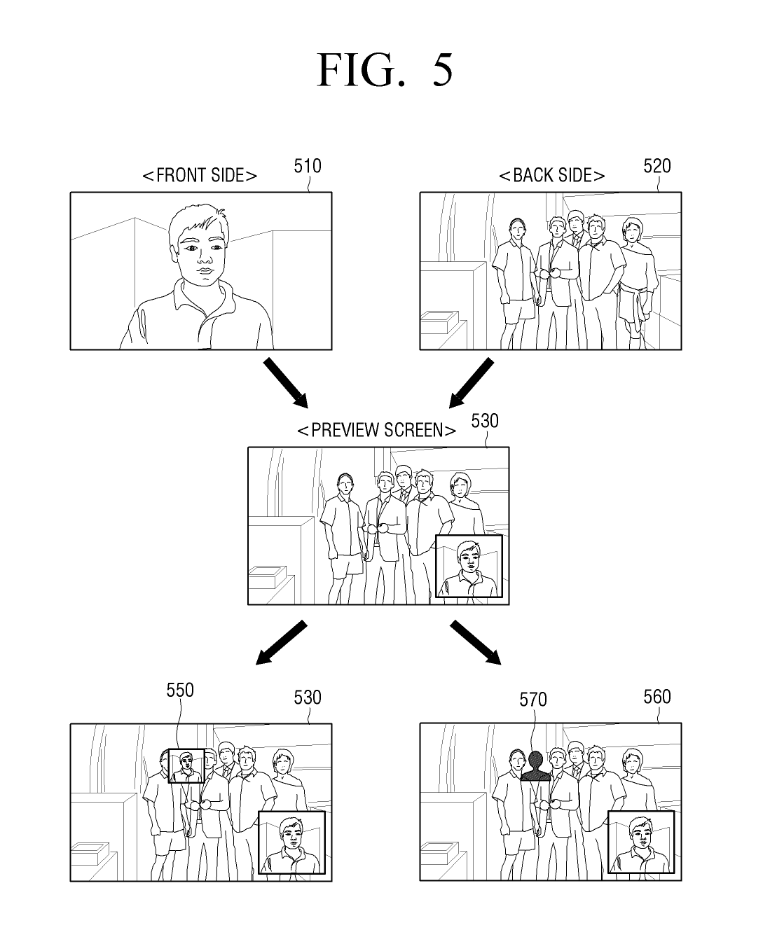

As another example, referring to FIG. 5, when an image 510 which is photographed in a front side and an image 520 which is photographed in a back side are illustrated in a left upper part and a right upper part of FIG. 5, respectively, a preview screen 530 is illustrated in the center of FIG. 5.

For example, as illustrated in FIG. 3B, if the selected mode is the second mode, and one of the areas among faces of a plurality of people included in an image which is photographed in a back side is determined as a location in which a person who is photographed in a front side may be composed.

In this case, as illustrated in left lower part of FIG. 5, the controller 130 may overlay and display on the preview screen 540 the guide GUI 550 composed of an image that is photographed in a front side at an area which is located among faces of a plurality of people included in an image which is photographed in a back side.

Alternatively, as illustrated in a right lower part of FIG. 5, the controller 130 may overlay and display on the preview screen 540 the guide GUI 570 composed of an icon of a specific shape at an area which is located among faces of a plurality of people included in an image which is photographed in a back side.

As described above, the guide GUI may be displayed on a preview screen at a location in which an object which is photographed in a front side is composed, and a user who photographs using the display apparatus 100 may recognize at which area an image of the user will be composed before photographing an image.

While it is explained that the guide GUI is displayed in a fixed manner at a location in which an object that is photographed in a front side may be composed, but this is merely exemplary, and a location of the guide GUI may be changed or displayed by a user command.

For example, the controller 130, when displaying the guide GUI, may distinguish and display a location which is determined as a candidate area in which an object which is photographed in a front side may be composed.

The controller 130 may display a specific icon semi-transparently at a location which is determined as a candidate area or display the location semi-transparently, but this is merely exemplary. A location which is determined as a candidate area may be distinguished from other areas using various methods and displayed.

The controller 130, when a user command to select a candidate area is input, may move the guide GUI which was displayed at an area in which an object which is photographed in a front side may be composed to an area which is selected by a user and display the guide GUI at the area.

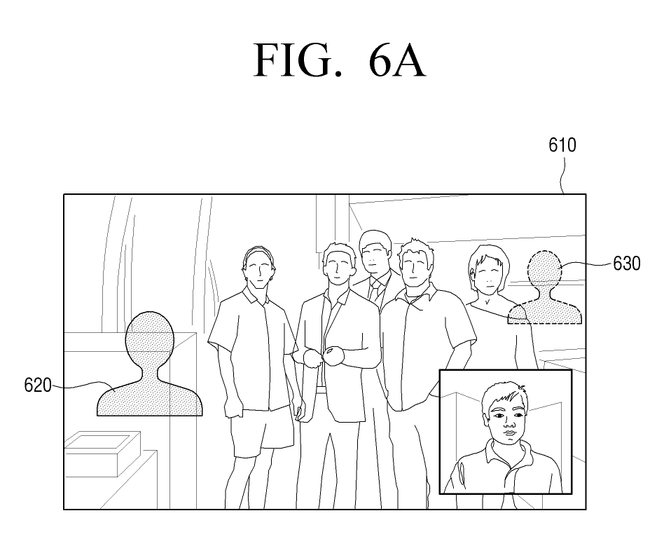

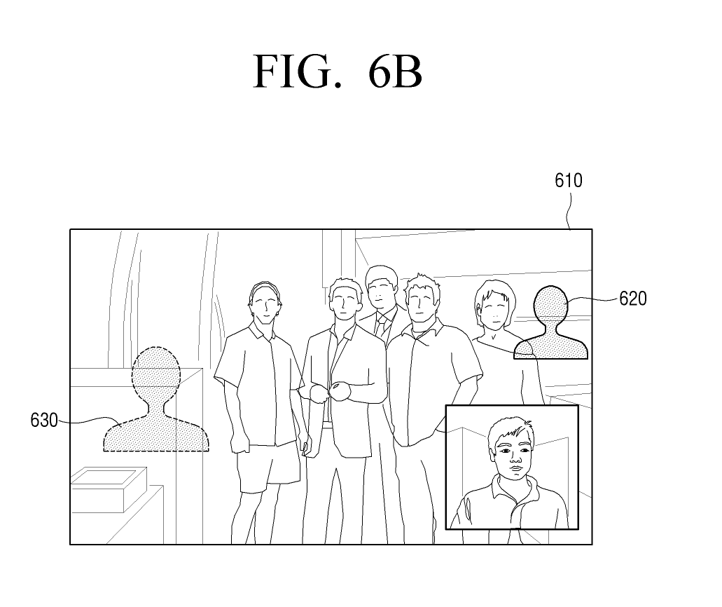

Referring to FIG. 6A, when the first mode is selected, the controller 130, on a preview screen 610, may determine a left area of a plurality of people as a location where a person who is photographed in a front side may be composed and display a guide GUI 620. In this case, the controller 130 may additionally display a semi-transparent icon 630 at a right area of a plurality of people which is determined as a candidate area.

In this case, when a user selects the semi-transparent icon 630, the controller 130, as illustrated in FIG. 6B, may display the guide GUI 620 which was displayed at a left area at an area where the semi-transparent icon 630 was displayed, and display the icon 630 which was displayed at a right area at an area where the guide GUI 620 was displayed.

In addition, the controller 130 may semi-transparently display a specific shape icon at a location where an object which is photographed in a front side may be composed and a location which is determined as a candidate area, or semi-transparently display both locations.

In this case, the controller 130, when a user command to select one of the locations is input, may display the guide GUI at a selected location.

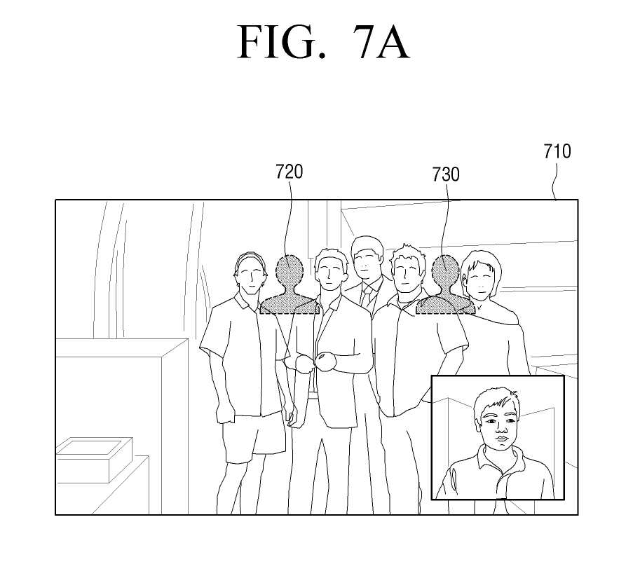

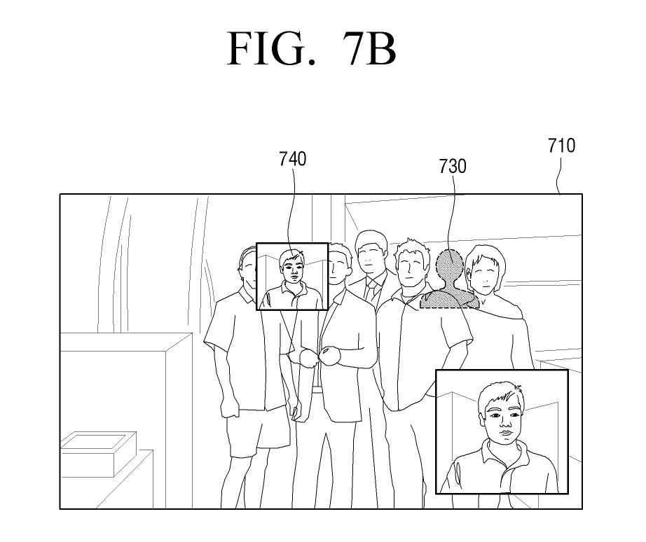

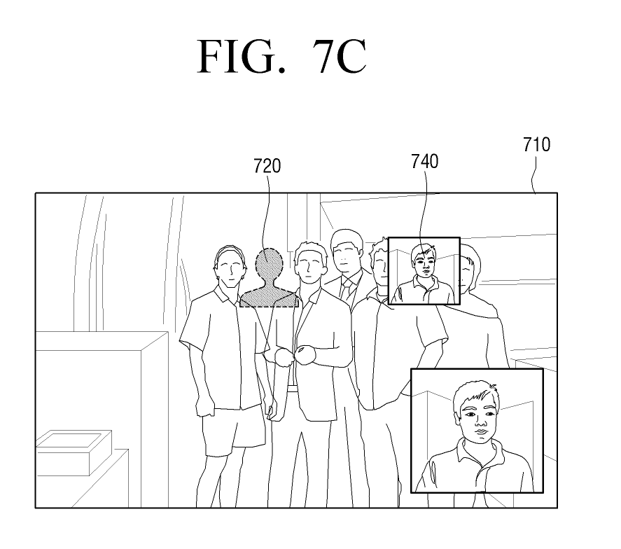

For example, as illustrated in FIG. 7A, when a second mode is selected, the controller 130, on a preview screen 710, may display semi-transparent icons 720 and 730 at a location which is determined as an area where an object which is photographed in a front side may be composed and a location which is determined as a candidate area.

In this case, when a user selects an icon 720 which is displayed between the first person and the second person, the controller 130 may display the guide GUI 740 at the selected area as illustrated in FIG. 7B.

Then, when a user selects an icon 730 which is displayed between the fourth person and the fifth person, the controller 130, as illustrated in FIG. 7C, may display a guide GUI 740 at a selected area and display the icon 720 at the area where the guide GUI 740 was displayed.

As described above, the guide GUI may be automatically displayed at a specific location or a location to be displayed may be changed according to a user command.

The controller 130, when a photographing command is input while the guide GUI is displayed on a preview screen, may capture an image which was photographed in a front side and a back side at the time when the photographing command was input.

At this time, the controller 130 may compose an object which is photographed in a front side with an image which is photographed in a back side and store the object.

For example, the controller 130 may segment an object which is present in an image which is photographed in a front side, and compose and store the segmented object according to the selected mode.

In this case, the controller 130 may compose the segmented object at a location where the guide GUI was displayed on a preview screen. That is, a location where the guide GUI is displayed may be changed according to modes, and thus, the controller 130 may compose an object which is photographed in a front side at an area where the guide GUI is displayed according to the selected mode.

For example, when a selected mode is a first mode, the guide GUI may be located at a left area or a right area of an image which is photographed in a back side, and thus, the controller 130 may compose an image which is photographed in a front side at the left area or the right area of the image which is photographed in a back side.

As another example, when a selected mode is a second mode, the guide GUI may be located among a plurality of objects included in an image which is photographed in a back side, and thus, the controller 130 may compose an object which is photographed in a front side among a plurality of objects included in the image photographed in a back side.

The controller 130 may detect an object which is present in an image that is photographed in a front side, segment the detected object image, and separate the object image from the image which is photographed in a front side. For example, the controller 130, based on a difference in tone values among adjacent pixels of the image which is photographed in a front side, may recognize contour (e.g., contour of face and body, etc.) of a person, detect a person from the image which is photographed in a front side, and segment the detected image of the person.

In addition, the controller 130, according to a selected mode, may compose an object which is segmented from the image that is photographed in a front side with an image which is photographed in a back side.

For example, when a selected mode is the first mode, the controller 130 may overlay the segmented object in an area where the guide GUI was displayed in an image which is photographed in a back side, and compose the segmented object with the image which is photographed in a back side. Here, when a selected mode is the first mode, the guide GUI may be located at a left area or a right area of a plurality of objects which are present in an image photographed in a back side.

Accordingly, the controller 130, when a selected mode is the first mode, may compose the segmented object at a left area or a right area of the image which is photographed in a back side.

In this case, the controller 130 may adjust a size of the segmented object to correspond to a size of a left area or a right area of a plurality of objects which are present in the image photographed in a back side, and overlay the adjusted object at a left area or a right area of a plurality of objects.

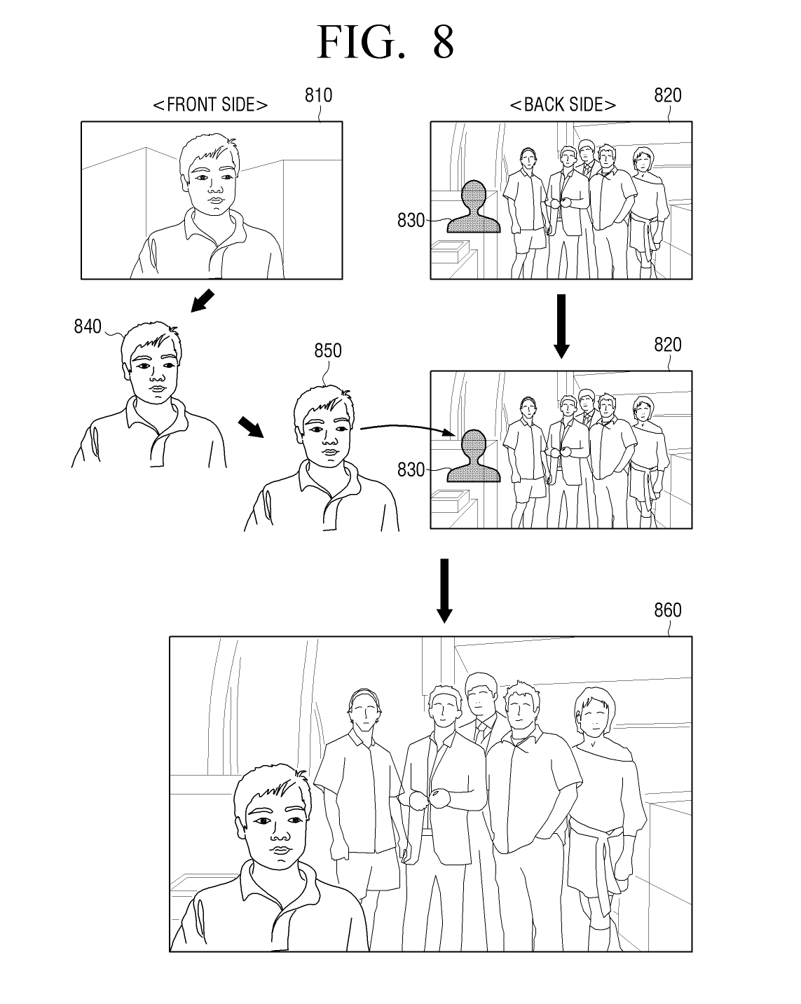

Referring to FIG. 8, when an image 810 which is photographed in a front side and an image 820 which is photographed in a back side are illustrated in a left upper part and a right upper part of FIG. 8, respectively, the guide GUI 830 is displayed at a left area of the image 820 which is photographed in a back side.

In this case, the controller 130 may segment an image 840 of a person from the image 810 which is photographed in a front side, and separate the image 840 of the person from the image 810.

In addition, the controller 130, after adjusting a size of the segmented image 840 of the person so that a face size of the segmented image 840 can be as half of a left area of the image 820 which is photographed in a back side, may overlay the adjusted image 850 in the left area of the image 820, and compose the adjusted image 850 with the image 820 which is photographed in a back side. Accordingly, an image 860 can be generated.

While it is described that a face size of the segmented image of a person is adjusted to be a size of a half of a left area, but this is merely exemplary, and a size of the segmented image can be adjusted diversely. For example, the controller 130 may adjust a size of the segmented image so that the segmented image is overlaid within a left area, or adjust a size of the segmented image so that a face size of the segmented image can be the same as the face size of a person who is located nearest to the area where the segmented image is overlaid.

When a selected mode is the second mode, the controller 130 may segment an object which is present at an area nearby an area where the guide GUI was displayed from an image which is photographed in a back side, separate the object from a background area, overlay an object segmented from an image which is photographed in a front side on the background area, additionally overlay the object segmented from the image which is photographed in a back side on the background area, and then compose the object segmented from the image which is photographed in a front side with the image which is photographed in a back side.

Here, when a selected mode is a second mode, the guide GUI may be located among a plurality of objects which are included in an image photographed in a back side.

Accordingly, the controller 130, when a selected mode is a second mode, may compose a segmented object among a plurality of objects included in an image which is photographed in a back side.

In this case, the controller 130 may adjust a size of a segmented image from an image which is photographed in a front side to correspond to a size of an object which is present nearby the area where the guide GUI is displayed from among the areas between a plurality of objects in an image photographed in a back side, and overlay the adjusted image with the image which is photographed in a back side.

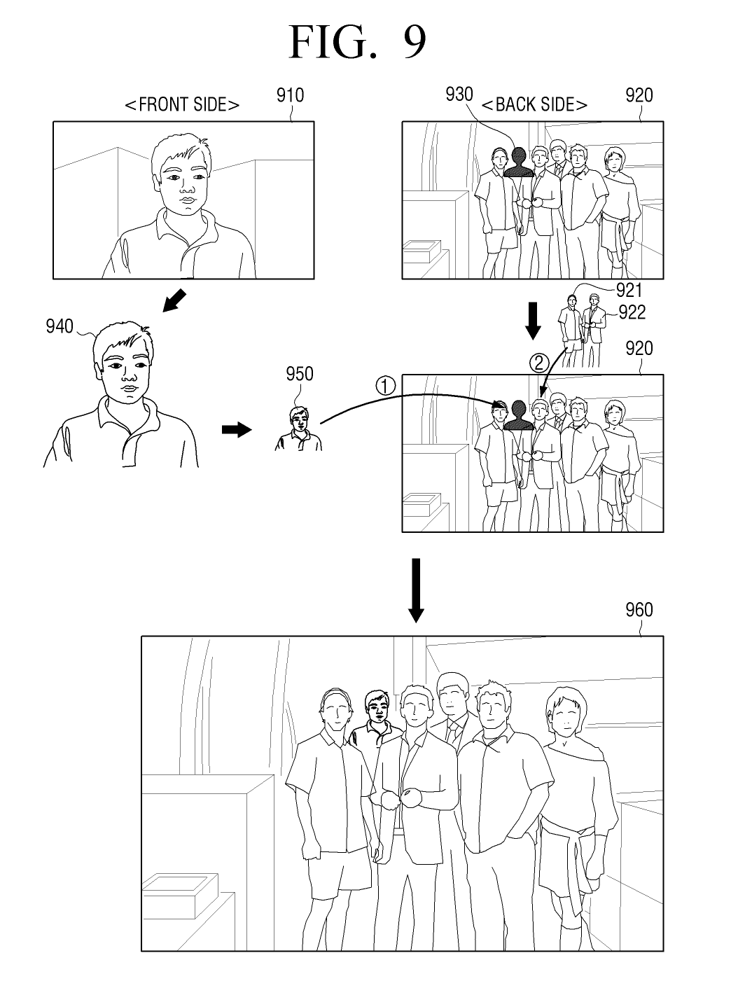

Referring to FIG. 9, when an image 910 which is photographed in a front side and an image 920 which is photographed in a back side are illustrated in a left upper part and a right upper part of FIG. 9, respectively, a guide GUI 930 is displayed between the first person and the second person from among a plurality of people included in an image which is photographed in a back side.

In this case, the controller 130 may segment an image of a person from the image 910 which is photographed in a front side and separate an image 940 of the person from the image 910.

The controller 130 may detect a person (e.g., a person 921) who is located nearest with an area where the guide GUI 930 is displayed from the image 920 which is photographed in a back side, calculate face size of the detected person, and adjust a size of the image 940 of a person so that the face size of the image 940 of the person is the same as the calculated face size. In this case, the controller 130 may further adjust a size of an upper body part of the image 940 of the person so that the size of the upper body part of the person is maintained after the face size is adjusted.

The controller 130 may segment people who are present around an area in which the guide GUI 930 was displayed from the image 920 which is photographed in a back side, and separate images 921 and 922 of people from the image 920.

The controller 130 may overlay the image 950 of a person whose size is adjusted at an area where the guide GUI 930 was displayed in the image 920 which is photographed in a back side, overlay the separated images 921 and 922 of people at the original location in the image 920, and compose the adjusted image 950 with the image 920 which is photographed in a back side. Accordingly, an image 960 which is composed may be generated.

While a size of an object which is photographed in a front side is adjusted before composing the object which is photographed in a front side with an image which is photographed in a back side, but this is merely exemplary.

For example, the controller 130 may adjust a color of face, a brightness of face, a direction of glance of a person who is photographed in a front side, or compose a lower body part with the upper body part of a person who is photographed in a front side.

The controller 130 may adjust a color of face of a person who is segmented from the image which is photographed in a front side so that the color of face of the person segmented from the image which is photographed in a front side may be the same (or similar) with a color of face of people around the area in an image which is photographed in a back side in which the segmented image is composed.

For example, the controller 130 may detect a person who is present in the location nearest an area in which a person segmented from an image which is photographed in a front side is composed in an image that is photographed in a back side, and determine a face color of the detected person. The controller 130 may adjust the face color of the person segmented from the image which is photographed in a front side so that the face color of the person segmented from the image photographed in a front side is the same as the determined face color.

In addition, the controller 130 may adjust a brightness of face of a person who is segmented from the image which is photographed in a front side so that the brightness of face of the person may be the same (or similar) with a brightness of face of people around the area in an image which is photographed in a back side in which the segmented image is composed.

For example, the controller 130 may detect a person who is present in the location nearest an area in which a person segmented from an image which is photographed in a front side is composed in an image that is photographed in a back side, and determine a face brightness of the detected person. The controller 130 may adjust the face brightness of the person segmented from the image which is photographed in a front side so that the face brightness of the person segmented from the image photographed in a front side is the same as the determined face brightness.

In addition, the controller 130 may adjust a direction of a gaze of a person who is segmented from the image which is photographed in a front side so that the direction of the gaze of the person segmented from the image which is photographed in a front side may be the same (or similar) with a direction of gaze of people around the area in an image which is photographed in a back side in which the segmented image is composed.

For example, the controller 130 may detect a person who is present in the location nearest an area in which a person segmented from an image which is photographed in a front side is composed in an image that is photographed in a back side, and determine a direction of the gaze of the detected person. The controller 130 may determine the direction of the gaze based on a location where pupil takes from the eyes of the detected person. In addition, the controller 130 may adjust the direction of the gaze of the person segmented from the image which is photographed in a front side so that the direction of the gaze of the person who is segmented from an image which is photographed in a front side be the same as the determined direction of the gaze.

In addition, the controller 130 may compose a lower body part of a person who is segmented from an image which is photographed in a front side.

For example, the controller 130 may detect a person who is present at the location nearest an area in which a person segmented from an image which is photographed in a front side is composed in an image which is photographed in a back side, and segment the lower body part of the detected person. The controller 130 may adjust a size of the segmented image of the lower body part to correspond to a size of an upper body part of the person segmented from the image photographed in a front side, and compose the adjusted image at a lower part of the upper body of the person who is segmented from the image which is photographed in a front side.

The controller 130, when composing a person included in an image which is photographed in a front side with an image which is photographed in a back side, may adjust a face of a person included in the image photographed in a front side so that at least one of a face size, a face color, a face brightness and a direction of gaze of the person is to be the same as those of people around the area to be composed, or compose the lower body part of a person who is present around the area to be composed with the upper part of a person included in an image which is photographed in a front side. Accordingly, the person included in the image which is photographed in a front side may be composed naturally with a person included in an image which is photographed in a back side.

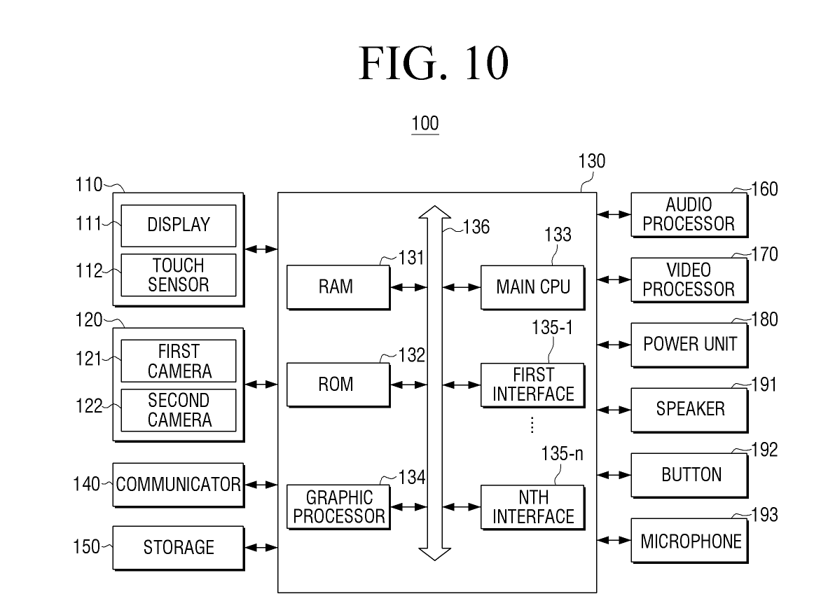

FIG. 10 is a block diagram to describe a detailed configuration of a display apparatus according to an exemplary embodiment. According to FIG. 10, the display apparatus 100 may include a user interface 110, a camera 120, a controller 130, a communicator 140, a storage 150, an audio processor 160, a video processor 170, a power unit 180, a speaker 191, a button 192, and a microphone 193. The parts overlapped with FIG. 1 will not be further explained.

The user interface 110 may be realized as a touch screen. The user interface 110 may include a display 111 to display various screens and a capacitive or resistive touch sensor 112 to detect a user touch.

The camera 120 may include a first camera 121 to photograph a front side of the display apparatus 100 and a second camera 122 to photograph a back side of the display apparatus 100.

The communicator 140 may communicate with various external devices. The communicator 140 may access an external server through an internet network or communicate with an external device through a mobile communication network.

The storage 150 stores an operating system (0/S) to operate the display apparatus 100.

The storage 150 may store various application programs and various data related to execution of the application program. For example, the storage 150 may store a cameral application and image data generated in accordance with execution of the application, or the like.

The audio processor 160 may perform an audio processing. For example, the audio processor 160 may perform various processing such as a decoding, an amplification, and a noise filtering of audio data.

The video processor 170 may perform a processing of video data. For example, the video processor 170 may perform various image processing such as a decoding, a scaling, a noise filtering, a frame rate conversion, and a resolution conversion with respect to video data.

The power unit 180 is an element which supplies power to each element of the display apparatus 100. The power unit 180 may be mounted on the display apparatus 100, or detachably mounted.

The speaker 191 is an element to output various audio data processed by the audio processor 160, notification sounds, or audio messages.

The button 192 may have various types such as a mechanical button formed at a front part, a side part, and a back part of the display apparatus 100, a wheel, or the like. For example, the button 192 may include a button to turn on or off power of the display apparatus 100.

The microphone 193 is a configuration to convert user voice or other sound to audio data. User voice which is input through the microphone 193 may be used during a call process or stored in the storage 150 by converting to audio data.

The display apparatus 100 may further include various external input ports to be connected with various external terminals such as a headset.

The controller 130 may include a random access memory (RAM) 131, a read-only memory (ROM) 132, a main CPU 133, a graphic processor 134, first to nth interface 135-1˜135-n, and bus 136.

The RAM 131, the ROM 132, the main CPU 133, the graphic processor 134, and the first to the nth interface 135-1˜135-n may be interconnected through the bus 136.

The first to nth interface 135-1 to 135-n are connected with the elements. One of the interfaces may be a network interface which is connected with an external apparatus through network.

The main CPU 133 performs booting by accessing the storage 150, using the 0/S stored in the storage 150. The main CPU 133 may perform various operations using various application programs and data stored in the storage 150.

In the ROM 132, a command set for system booting is stored. When power is supplied after a turn-on command is input, the main CPU 133 copies the O/S stored in the storage 150 to the RAM 131 according to a command stored in the ROM 132, executes the O/S, and boots the system. When booting is completed, the main CPU 133 copies various application programs stored in the storage 150 to the RAM 131, executes the application program copied to the RAM 131, and performs various operations.

The graphic processor 134 may generate a screen which includes various objects such as an icon, an image, and a text, and output the objects through the display 111.

The graphic processor 134 calculates an attribute value such as a coordinate value where each object is indicated according to a layout of a screen, a shape, a size, and a color, generates a screen having various layouts including an object based on the calculated attribute value, and displays the generated screen on the display 111.

In particular, the graphic processor 134 may generate a preview screen using an image which is photographed by the first camera 121 and an image which is photographed by the second camera 122. Here, a guide GUI may be displayed at a specific area of the preview screen.

The graphic processor 134 may segment an object from an image which is photographed by the first camera 121, adjust a size of the segmented objet image, and compose the segmented image with an image which is photographed by the second camera 122.

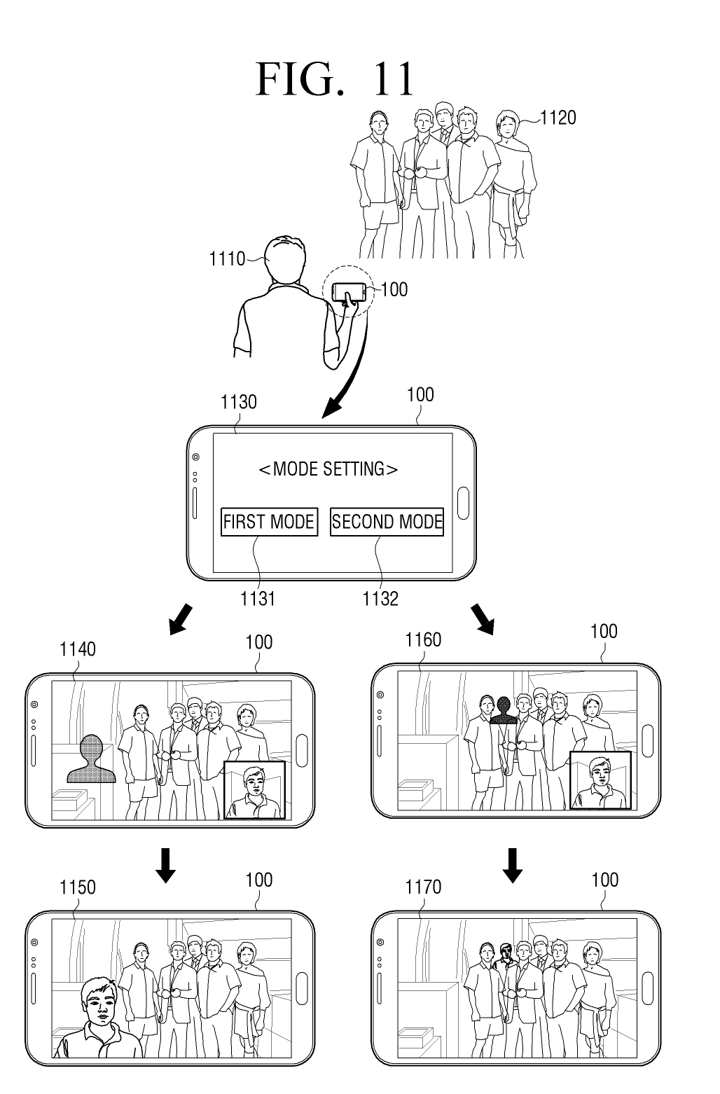

FIG. 11 is views to describe a method for composing images according to an exemplary embodiment.

A user 1110, by running a camera application in the display apparatus 100, may photograph the user 1110 who is located in a front side of the display apparatus 100 and a plurality of people 1120 who are present in a back side of the display apparatus 100.

In this case, a mode setting screen 1130 may be displayed in the display apparatus 100.

When a menu item 1131 corresponding to a first mode is selected in the mode setting screen 1130, the guide GUI may be displayed at a left area of a plurality of people who are photographed in a back side of the display apparatus 100, on a preview screen 1140.

Thereafter, when a photographing command is input, the display apparatus 100 may capture an image which is photographed in a front side and an image which is photographed in a back side. In this case, the display apparatus 100 may generate a composed image 1150 in which the user 1110 who is photographed in a front side is composed at an area where the guide GUI was displayed, and store the composed image 1150.

When a menu item 1132 corresponding to a second mode is selected in the mode setting screen 1130, the guide GUI may be displayed, on a preview screen 1160, at an area between the first person and the second person who are photographed in a back side of the display apparatus 100.

Thereafter, when a photographing command is input, the display apparatus 100 may capture an image which is photographed in a front side and an image which is photographed in a back side. In this case, the display apparatus 100 may generate a composed image 1170 in which the user 1110 who is photographed in a front side is composed at an area where the guide GUI is displayed, and store the composed image 1170.

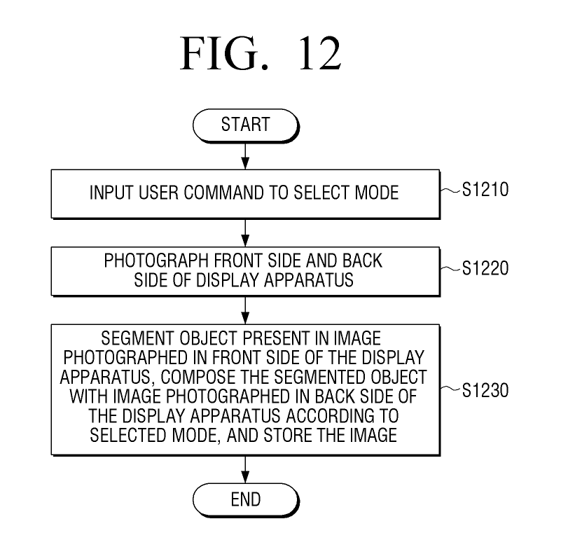

FIG. 12 is a flowchart to describe an image composition method of the display apparatus according to an exemplary embodiment.

A user command to select a mode to set a location where an image which is photographed in a back side of the display apparatus is composed with an object which is photographed in a front side of the display apparatus is composed is input (S1210).

A front side and a back side of the display apparatus is photographed (S1220), an object which is present in an image photographed in a front side of the display apparatus is segmented, the segmented object is composed with an image which is photographed in a back side of the display apparatus according to a selected mode, and the composed image is stored (S1230).

In this case, if an image which is photographed in a back side includes a plurality of objects, the selected mode may be a mode to set a location where an object which is photographed in a front side is to be composed based on a location of the plurality of objects.

For example, at S1230, when the selected mode is the first mode, the segmented object may be composed at a left area or a right area of an image which is photographed in a back side, and when the selected mode is the second mode, the segmented object may be composed among a plurality of objects included in an image which is photographed in the back side.

An image composition method according to an exemplary embodiment may further include displaying on a preview screen a guide GUI which indicates a location where an object which is photographed in a front side is composed with an image which is photographed in a back side. In this case, at S1230, the segmented object may be composed at a location where the guide GUI was displayed, on the preview screen, and the composed image is stored.

In this case, the guide GUI may be a preset icon or an image of an object which is photographed in a front side.

An image composition method to segment an object which is photographed in a front side with an image which is photographed in a back side has been described above.

A non-transitory computer readable medium in which a program which sequentially performs an image composition method according to various exemplary embodiments as described above is stored therein may be provided.

The non-transitory computer-recordable medium is not a medium configured to temporarily store data such as a register, a cache, or a memory but an apparatus-readable medium configured to semi-permanently store data. Specifically, the above-described various applications or programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided therein.

In addition, in a block diagram which illustrates the display apparatus does not illustrate a bus, but communication among each element of the display apparatus may be conducted through the bus. In addition, the display apparatus may further include a processor such as a CPU which performs various steps and a microprocessor, or the like.

The foregoing exemplary embodiments and advantages are merely exemplary and are not to be construed as limiting the inventive concept. The exemplary embodiments can be readily applied to other types of device or apparatus. Also, the description of the exemplary embodiments is intended to be illustrative, and not to limit the scope of the inventive concept, and many alternatives, modifications, and variations will be apparent to those skilled in the art.

What is claimed is:

1. A display apparatus, comprising:
a user interface configured to receive a user command to select a mode for setting a location in which an image which is photographed in a back side of the display apparatus is composed with an object which is photographed in a front side of the display apparatus;
a camera configured to photograph the front side and the back side of the display apparatus; and,
a controller configured to segment an object image from an image of the object which is photographed in the front side, compose the segmented object image with the image which is photographed in the back side according to the selected mode, and store the composed image.

2. The apparatus as claimed in claim 1, wherein if the image photographed in the back side comprises a plurality of objects,
the mode comprises a mode for setting a location in which the object which is photographed in the front side of the display apparatus is to be composed based on a location of the plurality of objects.

3. The apparatus as claimed in claim 1, wherein the controller is configured to adjust a size of the segmented object image to correspond to a size of an object included in the image photographed in the back side.

4. The apparatus as claimed in claim 1, wherein the controller is configured to compose, in response to selecting a first mode, the segmented object at a left area or a right area of the image which is photographed in the back side.

5. The apparatus as claimed in claim 1, wherein the controller is configured to compose, in response to selecting a second mode, the segmented object among a plurality of objects included in the image which is photographed in the back side.

6. The apparatus as claimed in claim 1, wherein the controller is configured to display a preview screen in which the object photographed in the front side is overlapped with the image photographed in the back side.

7. The apparatus as claimed in claim 6, wherein the controller is configured to display on the preview screen a guide graphic user interface (GUI) indicating the location in which the object that is photographed in the front side is composed with the image that is photographed in the back side, and compose the object at the location in which the guide GUI is displayed on the preview screen.

8. The apparatus as claimed in claim 7, wherein the guide GUI comprises an icon or an image of the object which is photographed in the front side.

9. The apparatus as claimed in claim 8, wherein the controller is configured to display, in response to selecting a first mode, the guide GUI at a left area of the image photographed in the back side, and display an icon at a right area of the image as a candidate area.

10. The apparatus as claimed in claim 8, wherein the controller is configured to display, in response to selecting a second mode, the guide GUI at an area in which the object photographed in the front side is composed among a plurality of objects included in the image photographed in the back side, and display an icon at a location among the plurality of objects as a candidate area.

11. An image composition method of a display apparatus, comprising:
receiving a user command to select a mode for setting a location in which an image which is photographed in a back side of the display apparatus is composed with an object which is photographed in a front side of the display apparatus;
photographing the front side and the back side of the display apparatus; and
segmenting an object image from an image of the object which is photographed in the front side, composing the segmented object image with the image which is photographed in the back side according to the selected mode, and storing the composed image.

12. The method as claimed in claim 11, wherein if the image photographed in the back side comprises a plurality of objects,
the mode comprises a mode for setting a location in which the object which is photographed in the front side of the display apparatus is to be composed based on a location of the plurality of objects.

13. The method as claimed in claim 11, wherein the composing comprises adjusting a size of the segmented object image to correspond to a size of an object included in the image photographed in the back side.

14. The method as claimed in claim 11, wherein the composing comprises, in response to selecting a first mode, composing the segmented object at a left area or a right area of the image which is photographed in the back side.

15. The method as claimed in claim 11, wherein the composing comprises, in response to selecting a second mode, composing the segmented object among a plurality of objects included in the image which is photographed in the back side.

16. The method as claimed in claim 11, further comprising displaying a preview screen in which the object photographed in the front side is overlapped with the image photographed in the back side.

17. The method as claimed in claim 16, wherein the displaying comprises displaying on the preview screen a guide graphic user interface (GUI) indicating the location in which the object that is photographed in the front side is composed with the image that is photographed in the back side, and composing the object at a location in which the guide GUI is displayed on the preview screen.

18. The method as claimed in claim 17, wherein the guide GUI comprises an icon or an image of the object which is photographed in the front side.

19. The method as claimed in claim 18, wherein the displaying comprises, in response to selecting a first mode, displaying the guide GUI at a left area of the image photographed in the back side and displaying an icon at a right area of the image as a candidate area.

20. The method as claimed in claim 18, wherein the displaying comprises, in response to selecting a second mode, displaying the guide GUI at an area in which the object photographed in the front side is composed among a plurality of objects included in the image photographed in the back side, and displaying an icon at a location among the plurality of objects as a candidate area.
